(19) United States
(12) Patent Application Publication
(10) Pub. No.: US 2015/0251071 A1
(43) Pub. Date: Sep. 10, 2015

(54) SYSTEM AND METHOD FOR EVALUATING A SWING OF ATHLETIC EQUIPMENT

(71) Applicant: KINETEK SPORTS, San Diego, CA (US)

(72) Inventors: Patrick M. Steusloff, San Diego, CA (US); Thomas H. Lupfer, San Diego, CA (US)

(21) Appl. No.: 14/643,295

(22) Filed: Mar. 10, 2015

Related U.S. Application Data
(60) Provisional application No. 61/950,330, filed on Mar. 10, 2014.

(51) Int. Cl. A63B 69/36; G01L 1/00; A63B 69/00; G01P 15/00

(52) U.S. Cl. CPC A63B 69/3632; G01P 15/00; G01L 1/00; A63B 69/0002; A63B 2220/56; A63B 2220/40; A63B 2220/801

(57) ABSTRACT

A shaft evaluation device and two sole evaluation devices communicate with a host device to collect, analyze, and store data related to a swing of athletic equipment. In a particular system and method, the shaft evaluation device transmits sensor data and notifies the host device that a swing has been detected, whereby the host device obtains sensor data collected by the two sole evaluation devices.

### CROSS REFERENCE TO RELATED APPLICATIONS

This application claims the benefit of U.S. Prov. Pat. App. No. 61/950,330 filed on Mar. 10, 2014, the entirety of which is hereby incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This disclosure relates to the general field of electronic biofeedback, and more specifically toward systems and methods for evaluating a swing of athletic equipment. A shaft evaluation device and two sole evaluation devices communicate with a host device to collect, analyze, and store data related to a swing of athletic equipment. In a particular system and method, the shaft evaluation device transmits sensor data and notifies the host device that a swing has been detected, whereby the host device obtains sensor data collected by the two sole evaluation devices.

The ability of an athlete to perform at peak levels is limited by the ability of the athlete to understand their present performance in individual movements, as well as their performance during an overall game. In the game of golf, an individual's overall performance has been tracked by a scorecard, and performance of a specific individual movement has been taught by a coach. However, the ability of a scorecard or coach is limited in that a scorecard only provides the number of strokes needed to reach a hole, and a coach can only teach improvement to aspects of movement that he perceives and understands.

Attempts have been made to overcome the limitations of a scorecard and coach, including stroke-logging programs. While these programs provide improved feedback to the user, as compared to a traditional scorecard, these programs have required the user to input each time he has made a stroke.

Attempts have also been made to improve accessibility of players to coaching and coaching tools. These have included the use of video capturing and other electronic sensing equipment. This equipment, however, can be large, bulky, and stationary. Furthermore, motion pictures are often incapable or unable to sufficiently convey the specific weight balance of an athlete during the process of swinging an athletic device, such as a golf club or baseball bat.

Further attempts have been made to improve the tracking of a swing using an electronic sensing device affixed to the shaft of athletic equipment. However, such an electronic sensing device affixed to the shaft of athletic equipment is unable to collect data related to the weight balance of the athlete and correlate this data with the positioning and timing of the swing by the athlete.

An effective swing, particularly a golf swing, is one that propels the ball the desired distance and direction, and is the result of delivering the club face to the ball on the correct path and with the correct face angle. It is widely recognized that the ability to consistently perform an effective swing depends on proper timing and balance of the body's movements. A properly timed and balanced movement is more powerful and more easily repeated. For example, golf players are instructed to transfer the majority of their weight to their back leg during the backswing, and to have a majority of their weight on their front leg at ball impact. It is considered a swing flaw to have the majority of weight on the front leg at transition (time of change from backswing to through swing), called a reverse pivot. Furthermore, golf players are coached to keep their weight inside of the back foot on the back swing. This allows for the hips to be cleared on the through swing allowing a path down the target line for the player's arms, hands, and the club. If a player “rides up” onto their back foot, they are out of balance at transition. Thus, it is important to not only have data on the player's swing and balance, but also be able to correlate these two data sets to a common time base. The prior art electronic sensing devices affixed to the shaft of athletic equipment can provide timing data, but not correlated balance data.

### SUMMARY OF THE INVENTION

The current invention includes a system and method for evaluating a swing of athletic equipment. A shaft evaluation device and two sole evaluation devices communicate with a host device to collect, analyze, and store data related to a swing of athletic equipment. In a particular system and method, the shaft evaluation device transmits sensor data and notifies the host device that a swing has been detected, whereby the host device obtains contemporaneous sensor data collected by the two sole evaluation devices.

One embodiment of the current disclosure is a system for measuring data obtained from a shaft evaluation device and two sole evaluation devices during an athlete's swing of athletic equipment. The shaft evaluation device includes a sensor configured to be mounted parallel to the longitudinal axis of the elongated shaft of the athletic equipment; an accelerometer configured to measure the movement of the athletic equipment in three dimensional space; and a radio configured to wirelessly receive data from and transmit data to the host device. Each sole evaluation device includes a plurality of pressure sensors that reflect the downward pressure by the foot at their respective locations and generate a proportional electronic signal; and a radio configured to wirelessly receive data from and transmit data to the host device.

Another embodiment of the current disclosure includes a system and method for measuring and correlating data by a host device obtained from a shaft evaluation device and two sole evaluation devices during an athlete's swing of athletic equipment. The shaft evaluation device includes a radio configured to wirelessly transmit data to and receive data from the host device; a ball-strike sensor configured to be mounted collinear with the longitudinal axis of the elongated shaft of the athletic equipment; an accelerometer configured to measure the movement of the athletic equipment in three-dimensional space. Each sole evaluation device includes four pressure sensors that reflect the downward pressure by the foot at their respective locations and generate a proportional electronic signal; and a radio configured to wirelessly receive data from and transmit data to the host device. The host device includes a radio configured to wirelessly transmit data to and receive data from the shaft evaluation device and the sole evaluation devices. The shaft evaluation device samples data from the accelerometer to obtain movement data; compares the sampled data from the accelerometer to pre-determined values of a generic swing; samples data from the ball-strike sensor; compares the sampled data from the ball-strike sensor to pre-determined criteria of a ball strike; and detects a ball strike when the sampled data from the accelerometer matches the pre-determined values and when the sampled data from the ball-strike sensor meets pre-determined criteria. The sole evaluation devices sample data from each of the four pressure sensors; and save the sampled data to one or more circular buffers. Upon the shaft evaluation device determining that a ball strike has occurred, the shaft evaluation device transmits data to the host device. Upon the host device receiving data from the shaft evaluation device indicating that a ball strike has occurred, the host device transmits a request to the sole evaluation devices requesting their respective sampled data. Upon a sole evaluation device receiving data from the host device requesting its respective sampled data, the sole evaluation device transmits sampled pressure sensor data stored in its circular buffer(s) to the host device. Upon receiving the sampled pressure sensor data from each of the sole evaluation devices, the host device correlates the data from the shaft evaluation device with the data from the sole evaluation devices.

A further embodiment of the current disclosure includes a method for linking and synchronizing a shaft evaluation device and two sole evaluation devices with a host device. The shaft evaluation device includes a radio configured to wirelessly transmit data to and receive data from the host device, and an internal clock. Each sole evaluation device includes a radio configured to wirelessly receive data from and transmit data to the host device, and an internal clock. The host device includes a radio configured to wirelessly transmit data to and receive data from the shaft evaluation device and the sole evaluation devices. The host device also includes an internal clock. The shaft evaluation device transmits data to the host device to create a new connection. In response, the host device transmits to the shaft evaluation device timestamp data of the current time of the host device, and the shaft evaluation device updates its internal clock to match that of the transmitted timestamp from the host device. Each sole evaluation device transmits data to the host device to create a new connection. In response, the host device transmits to the sole evaluation device timestamp data of the current time of the host device, and the sole evaluation device updates its internal clock to match that of the transmitted timestamp from the host device. Subsequent data transmitted from the shaft evaluation device and the sole evaluation devices include a timestamp from its internal clock that has previously been synchronized by the host device.

Another embodiment of the current disclosure includes a battery operated shaft evaluation device attached to the butt-end of a golf club and is comprised of sensors, a Bluetooth radio, and firmware; as well as pressure sensing shoe inserts, or sole evaluation devices, comprised of pressure sensors that reflect the downward pressure on the foot and generate a proportional electronic signal. The shaft evaluation device communicates sensor data to a Bluetooth equipped mobile computing device such as a smart phone or tablet. The data is analyzed and broken down to determine the various motions that comprise a golf swing. With millisecond precision, the initiation of key phases of a golf swing are determined, including the setup, takeaway, and transition. These phases are referenced to the instant the club collides with the golf ball. The analysis is done on the shaft evaluation device, with the resulting data transmitted to the host mobile computing device. Additional analysis of the sensor data obtained from the shaft evaluation device occurs on the mobile computing device. Such parameters as club head speed, club face angle, and swing path are computed on the host device, since these are computationally intense and best performed on the host mobile computing device. The embodiment also includes sole evaluation devices that include multiple pressure sensors for each foot. The location of the sensors allows the determination of how the player is balanced on each foot (i.e. heel vs. toe, inside vs. outside) and overall (i.e. right foot vs. left foot). The pressure sensing shoe inserts are each connected to a local microcontroller, Bluetooth radio, and firmware. The pressure data is sent to the Bluetooth equipped mobile computing device such as a smart phone or tablet.

In order to integrate foot pressure sensing data with swing component timing, separate computing devices must be time synchronized. In one embodiment, the host device, or mobile computing device, is used as the time master. Upon establishment of a Bluetooth connection with a device, the mobile computing device transmits its time to the remote device (evaluation device). The remote device immediately sets its real time clock to the received time. This process is repeated for all remote devices, such as the shaft evaluation devices and the sole evaluation devices. Subsequent data returned to the mobile computing device is time stamped and therefore is able to be merged into a common time base.

In yet another embodiment, the remote devices transmit their current time to the mobile computing device. The mobile computing device stores the times provided by each associated remote devices. For example, the mobile computer device stores the difference between the remote device's time and the mobile computer device's time. This time adjustment is then used to adjust the timestamp sent with the data from each remote device to synchronize and merge that data into a common time base.

Another embodiment of the current disclosure is a system for measuring data obtained from a shaft evaluation device and two sole evaluation devices during an athlete's swing of an article of athletic equipment. The shaft evaluation device includes a sensor configured to be mounted parallel to the longitudinal axis of the elongated shaft of the athletic equipment; an accelerometer configured to measure the movement of the athletic equipment in three dimensional space; a gyroscope configured to measure the orientation of the athletic equipment; and a radio configured to wirelessly receive data from and transmit data to the host device. Each sole evaluation device includes a plurality of pressure sensors that reflect the downward pressure by the foot at their respective locations and generate a proportional electronic signal; and a radio configured to wirelessly receive data from and transmit data to the host device. The addition of the gyroscope to the shaft evaluation device enables the shaft evaluation device to provide a more accurate determination of the overall movement of the athletic equipment.

With swing data and balance data merged into a common time base, it is possible to determine whether a player is reverse pivoting, swaying, or otherwise has an incorrect swing because the balance data is referenced to the timing components of the swing.

It is an object of the invention to provide a system and method for measuring swing forces and weight balance of an athlete.

It is another object of the invention to provide a system and method for collecting and correlating swing forces and weight balance of an athlete during a swing of athletic equipment.

It is a further object of this invention to provide a method for linking a shaft evaluation device and two sole evaluation devices with a host device.

As used herein, the term “memory” includes computer readable mediums; the term “timestamp” means a time value, including a unix timestamp, a MySQL datetime string, and ISO 8601 date and time representations; and the term “radio” means an electronic component capable of transmitting and receiving wireless signals. Furthermore, terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

A particular embodiment of the current disclosure is a system comprising a host device, where the host device comprises a processor, memory, and a radio; a shaft evaluation device, where the shaft evaluation device comprises a ball-strike sensor, an accelerometer, a microcontroller, a radio, and memory; where the radio of the shaft evaluation device is in wireless communication with the radio of the host device; and a sole evaluation device, where the sole evaluation device comprises a pressure sensor, a microcontroller, memory, and a radio, where the radio of the sole evaluation device is in wireless communication with the radio of the host device. The memory of the shaft evaluation device comprises a circular memory buffer. The memory of the sole evaluation device comprises a circular memory buffer. The pressure sensor of the sole evaluation device is located in a heel portion of the sole evaluation device. The sole evaluation device further comprises an additional pressure sensor, where the additional sensor is located in a ball portion of the sole evaluation device. The shaft evaluation device further comprises programming logic executed by the microcontroller and for interfacing with the ball-strike sensor, accelerometer, radio, and memory, the programming logic configured to: sample data from the ball strike sensor and accelerometer; store the sampled data in the memory to create sampled data records; and determine if a ball strike occurred during a swing. The programming logic of the shaft evaluation device is further configured to transmit at least a portion of the sampled data records to the host device. Each sampled data record includes a timestamp, or less than all of the sampled data records include a timestamp. The sole evaluation device further comprises programming logic executed by the microcontroller and for interfacing with the pressure sensor, radio, and memory, the programming logic configured to: sample data from the pressure sensor; store the sampled data in the memory to create sampled data records; and transmit at least a portion of the of the sampled data records to the host device. The shaft evaluation device further comprises programming logic executed by the microcontroller and for interfacing with the radio, the programming logic configured to request a timestamp from the host device. The shaft evaluation device further comprises programming logic executed by the microcontroller and for interfacing with the radio, the programming logic configured to transmit a timestamp to the host device.

Another embodiment of the current disclosure is a method comprising sampling data from a ball-strike sensor and an accelerometer of a shaft evaluation device, where each sampled data is referred to as a shaft sampled data record; storing the shaft sampled data records in memory; sampling data from a plurality of pressure sensors of a sole evaluation device, where each sampled data of a sole evaluation device is referred to as a sole sampled data record; storing the sole sampled data records in memory; determining whether a ball impact occurred during a swing; and transmitting some or all of the shaft sampled data records and some or all of the sole sampled data records to a host device. Sampling data from a ball-strike sensor and an accelerometer of a shaft evaluation device occurs at set intervals of time. Sampling data from a plurality of pressure sensors of a sole evaluation device occurs at set intervals of time. The shaft sampled data records are transmitted to the host device only if it was determined that a ball impact occurred during a swing. Each shaft sampled data record comprises a timestamp, or a timestamp is transmitted to the host device with the shaft sampled data records, in which case the method further comprises the step of calculating, on the host device, a timestamp for a shaft sampled data record using the transmitted timestamp and a set interval of time.

An additional embodiment of the current disclosure is a method comprising sampling data from a ball-strike sensor and an accelerometer of a shaft evaluation device at set intervals of time, where each sampled data is referred to as a shaft sampled data record, where the shaft evaluation device is secured to an article of athletic equipment; storing the shaft sampled data records in memory; sampling data from a plurality of pressure sensors of a first sole evaluation device at set intervals of time, where each sampled data of a first sole evaluation device is referred to as a first sole sampled data record; storing the first sole sampled data records in memory; sampling data from a plurality of pressure sensors of a second sole evaluation device at set intervals of time, where each sampled data of a second sole evaluation device is referred to as a second sole sampled data record; storing the second sole sampled data records in memory; determining whether a ball impact occurred during a swing; transmitting some or all of the shaft sampled data records to a host device if it was determined that a ball impact occurred during a swing; transmitting some or all of the first sole sampled data records to the host device upon request by the host device; and transmitting some or all of the second sole sampled data records to the host device upon request by the host device; whereby data about the spatial movement of the article by a user can be correlated with the weight balance of the first sole evaluation device and second sole evaluation device.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description.

### BRIEF DESCRIPTION OF THE FIGURES

The accompanying drawings, which are incorporated in and form a part of this specification, illustrate embodiments of the invention and together with the description, serve to explain the principles of this invention.

FIG. 1A is a cross-sectional view of a shaft evaluation device according to selected embodiments of the current disclosure, affixed to the shaft of an article of athletic equipment.

FIG. 1B is a perspective view of a shaft evaluation device according to selected embodiments of the current disclosure, affixed to the shaft of an article of athletic equipment.

FIG. 2 is a schematic view of the interactions between the shaft evaluation device, sole evaluation devices, and the host device, according to selected embodiments of the current disclosure.

FIG. 3 is a schematic view of a sole evaluation device according to selected embodiments of the current disclosure.

FIG. 4 is a schematic view of a sole evaluation device with an additional toe sensor according to selected embodiments of the current disclosure.

FIG. 5 is a schematic view of a sole evaluation device with sixteen sensors according to selected embodiments of the current disclosure.

FIG. 6 is a flow chart depicting a method of setting up the system for evaluating a swing of athletic equipment from the perspective of an evaluation device, according to selected embodiments of the current disclosure.

FIG. 7 is a flow chart depicting a method of a shaft evaluation device gathering and processing data for evaluating a swing of athletic equipment according to selected embodiments of the current disclosure.

FIG. 8 is a flow chart depicting a method of a sole evaluation device gathering and processing data for evaluating a swing of athletic equipment according to selected embodiments of the current disclosure.

FIG. 9 is a flow chart depicting a method of providing a timestamp to an evaluation device according to selected embodiments of the current disclosure.

FIG. 10 is a flow chart depicting a method of collecting and storing data for evaluating a swing of athletic equipment.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

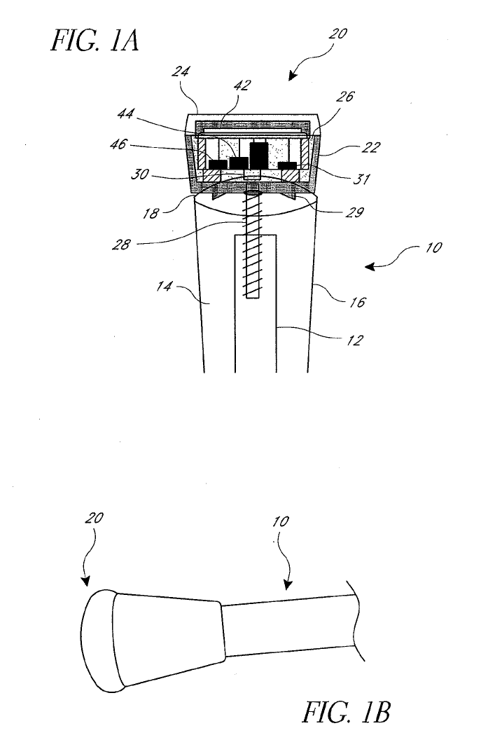

FIG. 1A is a cross-sectional view of a shaft evaluation device according to selected embodiments of the current disclosure, affixed to the shaft of an article of athletic equipment. In a particular embodiment, the shaft evaluation device is similar to that disclosed in U.S. patent application Ser. No. 13/244,141 filed on Sep. 23, 2011, now issued as U.S. Pat. No. 8,840,483 (the “Swing Evaluation Disclosure”), the entirety of which is hereby incorporated by reference. The piece or article of athletic equipment 10 can include a shaft 12 covered by a grip section 14 having a grip 16 and a grip end 18. In embodiments wherein the athletic equipment is a racquet, club, or bat, the grip section 14 can be cylindrical, with the grip 16 extending longitudinally along the outer circumference of the grip section 14. The grip end 18 in such an embodiment can be located at the termination point of the grip section 14. The shaft evaluation device includes a housing 22 and a cap 24. The housing 22 and cap 24 together define a hollow volume 26 in which components of the shaft evaluation device 20 are held. A screw 28 affixes the shaft evaluation device 20 to the athletic equipment 10. Teeth 29 assist in securing the housing 22 of the evaluation device 20 to the grip end 18 of the athletic equipment 10.

The housing 22 of the shaft evaluation device 20 holds components including a microphone 30. The microphone is a sensor (ball-strike sensor) that assists in the evaluation of a swing and detection of a ball strike by detecting noise and vibration in the athletic equipment 10. An additional component in the housing 22 is an accelerometer 31. The accelerometer 31 assists in the evaluation of a swing and detection of a ball strike by measuring the accelerations experienced by the accelerometer. These measurements can be used to evaluate tempo, timing, speed and other aspects of a swing. Furthermore, data collected from the accelerometer is stored to a memory and transmitted to a host device when an appropriate ball strike is detected. A battery is also included within the housing 22 to power the various electrical components of the shaft evaluation device. A radio is included within the housing 22, such as a Bluetooth® radio enabling the shaft evaluation device to wirelessly transmit and receive data to and from other radios of electronic devices. A microcontroller 46 controls the various components of the shaft evaluation device. The microcontroller 46 scans and samples data from the various sensors, such as the microphone sensor and the accelerometer. It stores the sampled data into buffers, and in a particular embodiment, a circular buffer, as well as analyzes and compares the data to determine whether a ball strike has occurred, and whether the ball strike occurred during an appropriate swing.

When the comparison of the signals received from the accelerometer 31 or the microphone 30 sensors match criteria for determining a swing and ball strike, the microcontroller 46 can signal the radio 44 to transmit information relating to the swing and/or ball strike to the host computer. More specifically, this information can include the sampled data from the sensors.

Some embodiments of the shaft evaluation device determine the occurrence of a swing and ball strike based upon signals received from the accelerometer and the microphone. The microcontroller continuously samples data and temporarily stores the most recent data in an electronic memory device, such as a circular buffer. The amount of time may depend upon the athlete herself, the athletic equipment, and other factors, but in particular embodiments, the time period for data storage is configured to save one second, two seconds, five seconds, ten seconds, and fifteen seconds of sampled data. The microcontroller can be configured to sample data at 10 Hz, 50 Hz, 100 Hz, 500 Hz, 1000 Hz, or other frequencies as desired. A person skilled in the art will recognize that the present disclosure is not limited to sampling and/or storing data over a specific time frame or at a specific rate, but rather that the time frame and rate can be adjusted for the desired use of the system and method.

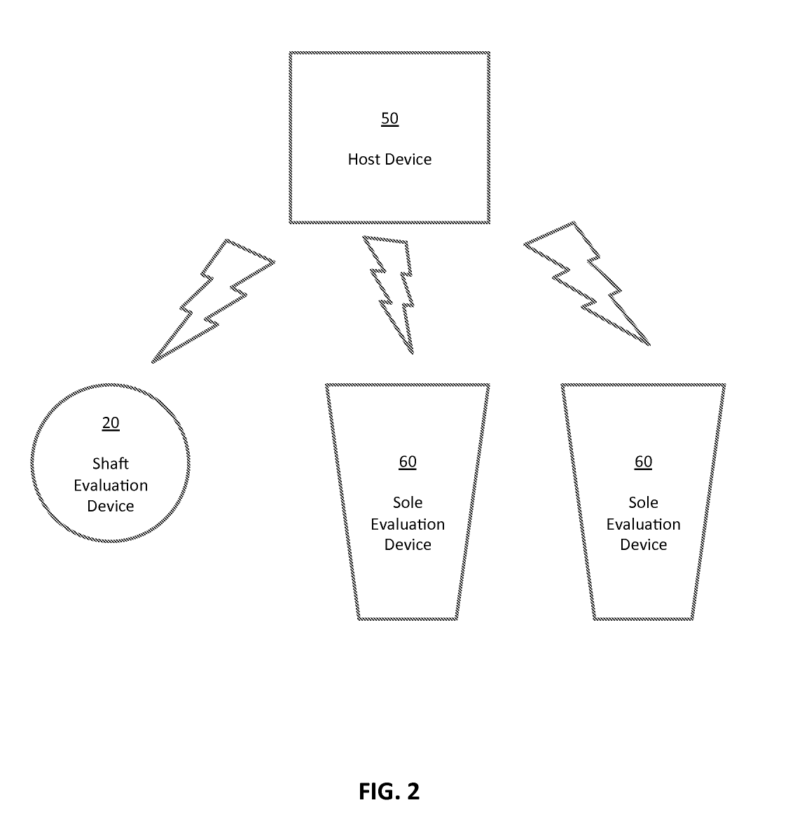

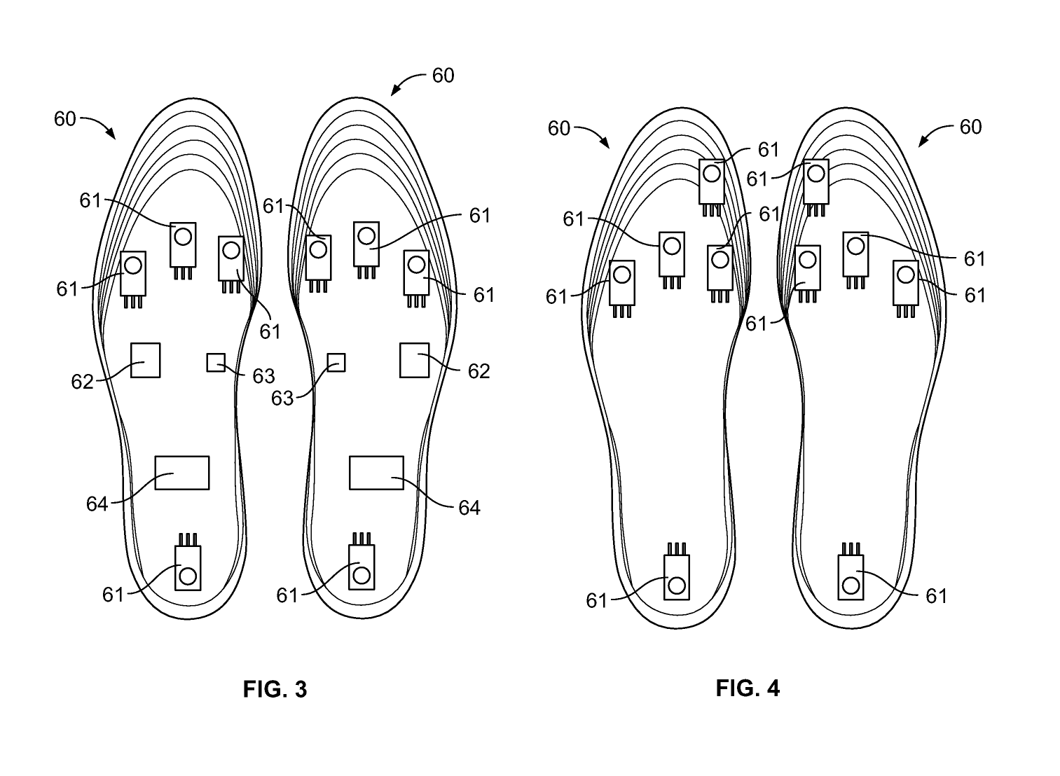

FIG. 2 is a schematic view of the interactions between the shaft evaluation device, sole evaluation devices, and the host device, according to selected embodiments of the current disclosure. The shaft evaluation device 20 and the sole evaluation members 60 each connect to and interact with the host device 50 via wireless signals.

The wireless communications between the devices of the system and method of the current disclosure should have a range of at least ten feet under normal conditions. This allows for a sufficient distance between the evaluation devices and the host device such that they may communicate throughout the swing and ball strike by the athlete without creating an undue burden on the athlete to accommodate the system and method or otherwise affecting her athletic movements. A particular embodiment of the current disclosure uses Bluetooth standard radios and communication protocols between the host device and the evaluation devices, including the shaft evaluation device and the sole evaluation devices. A person skilled in the art will recognize that the present disclosure is not necessarily limited to a particular type of radio or transmitter, but rather various different radio and transmission types and protocols may be implemented without departing from the scope of the current disclosure.

FIG. 3 is a schematic view of a sole evaluation device according to selected embodiments of the current disclosure. The sole evaluation device 60 includes a plurality of pressure sensors 61 (in this figure, four), a microcontroller 62, a radio 63, and a battery 64. Each pressure sensor 61 measures the force acting upon that sensor, and this measurement can be sampled by the microcontroller 62. Furthermore, the sampled data collected from the pressure sensors 61 is stored to a memory by the microcontroller. A battery 64 is also included within the sole evaluation device 60 to power the various electrical components of the sole evaluation device. The radio 63 is included within sole evaluation device 60, such as a Bluetooth® radio enabling the sole evaluation device to transmit and receive data to and from other electronic devices. The microcontroller 62 controls the various components of the sole evaluation device 60. The microcontroller 62 scans and samples data from the various sensors, such as the pressure sensors. It stores the sampled data into buffers, and in a particular embodiment, a circular buffer. Upon receiving a request via the radio from a host device, the microcontroller 62 causes the sampled data stored in its buffers to be transmitted to the host device via the radio 63.

In an alternative embodiment, the radio 63, battery 64, and/or microcontroller 62 are located outside of the sole evaluation device. For example, the plurality of pressure sensors 61 are located within the sole evaluation device 60, and connected via wires to an external housing containing the radio 63, battery 64, and microcontroller 62. This enables a thinner profile of the sole evaluation device to provide better comfort to the user. Furthermore, larger and/or replaceable batteries (such as readily available AAA sized batteries) may be used when the battery is stored in an external housing. Another example provides for the sole evaluation device 60 to include the pressure sensors 61, radio 63, and microcontroller within the sole evaluation device, and connected via wires to an external housing that contains the battery 64. One skilled in the art will appreciate that the use of the term “battery” may include multiple, separate batteries.

The battery 64 of sole evaluation device 60 can be charged via a hard-wired electrical connection, such as mini USB plug. Alternatively, charging may occur wirelessly, such as through induction. A person skilled in the art will recognize that the present disclosure is not limited to the aforementioned ways of charging the battery, but rather other methods and means of charging the battery may be incorporated, including solar power and power generation from kinetic movement. As mentioned above, replaceable/disposable batteries may be used as well. One skilled in the art will appreciate that the use of the term “battery” may include multiple, separate batteries.

In FIG. 3, the placement of the four pressure sensors has one towards the heel of the sole evaluation device, and three towards the front or “ball” portion of the sole evaluation device. Such a configuration allows for determining not only the total pressure or weight applied on each sole, but also the weight distribution of the athlete on the particular sole. Thus, using two sole evaluation devices, the system can determine the weight balance between the left and right foot of an athlete at a given point in time during a swing. Furthermore, the plurality of pressure sensors in each sole evaluation device enables the system to determine where the weight of the athlete is applied for each foot. For example, an athlete may have an appropriate weight balance between the left and right foot during a swing, but may be applying that weight substantially on her heels instead of more on the front of her feet.

FIG. 4 is a schematic view of a sole evaluation device with an additional toe sensor according to selected embodiments of the current disclosure. The additional toe sensor provides additional sampled data to the system and method for determining the weight balance over the sole evaluation device.

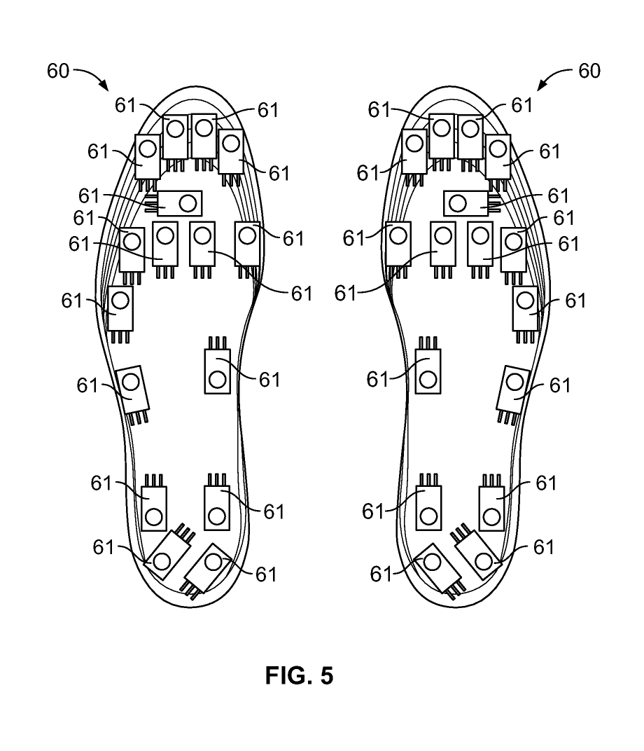

FIG. 5 is a schematic view of a sole evaluation device with sixteen sensors according to selected embodiments of the current disclosure. The additional sensors provide additional sampled data to the system and method for determining the weight balance over the sole evaluation device.

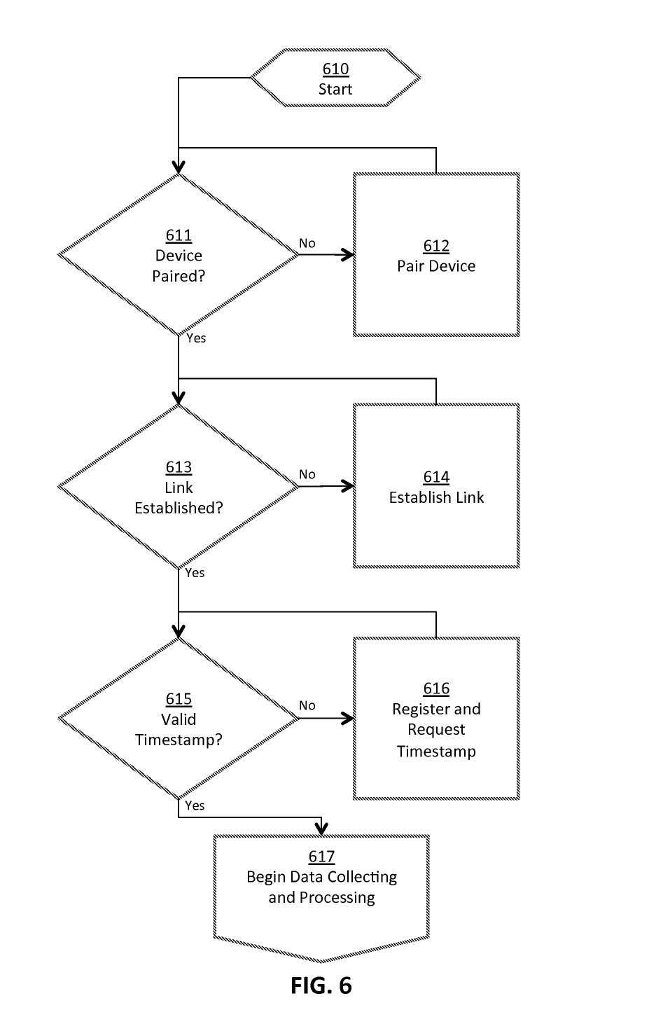

FIG. 6 is a flow chart depicting a method of setting up the system for evaluating a swing of athletic equipment from the perspective of an evaluation device, according to selected embodiments of the current disclosure. Each evaluation device must be paired with a host device and synchronize its clock with that of the host device. The method starts 610 and first determines whether the evaluation device has been paired 611 with the host device. Pairing creates a bond between the host device and the evaluation device. If the evaluation device is not paired or bonded with the host device, the two devices must be paired together 612. If the evaluation device is paired to the host device, or if the pairing process was successful, the evaluation device then determines whether a link has been established with the host device. If a link is not established, then the evaluation device establishes a link with the host device. If a link is established, or once the link has been established, the evaluation controller then determines whether it has a valid timestamp. Having a valid timestamp, discussed in more detail below, is necessary for correlating the sampled swing data from a shaft evaluation device with sampled pressure sensor data from sole evaluation devices. If no valid timestamp is available, the evaluation device registers and requests a timestamp 616 from the host device. Furthermore, during the request for a timestamp process, the evaluation device may send additional data that uniquely identifies itself to the host device. If the evaluation device has a valid timestamp, or has obtained a valid timestamp, the evaluation device begins data collecting and processing 617.

As stated above, the timestamp provided by the host device is used to synchronize the clock of the evaluation device with that of the host device. Once the clock of the evaluation device has been synchronized with the clock of the host device, it is nonetheless possible for the two clocks to go out of sync after a period of time. This can be due to normal tolerances in the clock of each device, or due to more significant errors, such as insufficient power (for example, a drained battery). To account for this, the timestamp provided by the host device may also include an expiration date. After this expiration date, the timestamp provided by the host device will no longer be valid, and the evaluation device should obtain a new timestamp from the host device. Alternatively, the evaluation device may have its own expiration period for a timestamp obtained from a host device. When its internal expiration period expires, the timestamp will no longer be valid, and a new timestamp should be obtained from a host device.

In one embodiment, the clock of the evaluation device is synchronized with the host device by sending the current timestamp of the evaluation device to the host device. During the register and request timestamp step 616, the evaluation device transmits its timestamp to the host device. The host device then compares the timestamp of the evaluation device with its own clock, and creates an offset and stores that offset. When subsequent data is transmitted from the evaluation device to the host device, the host device can use the offset to correlate the data between evaluation devices.

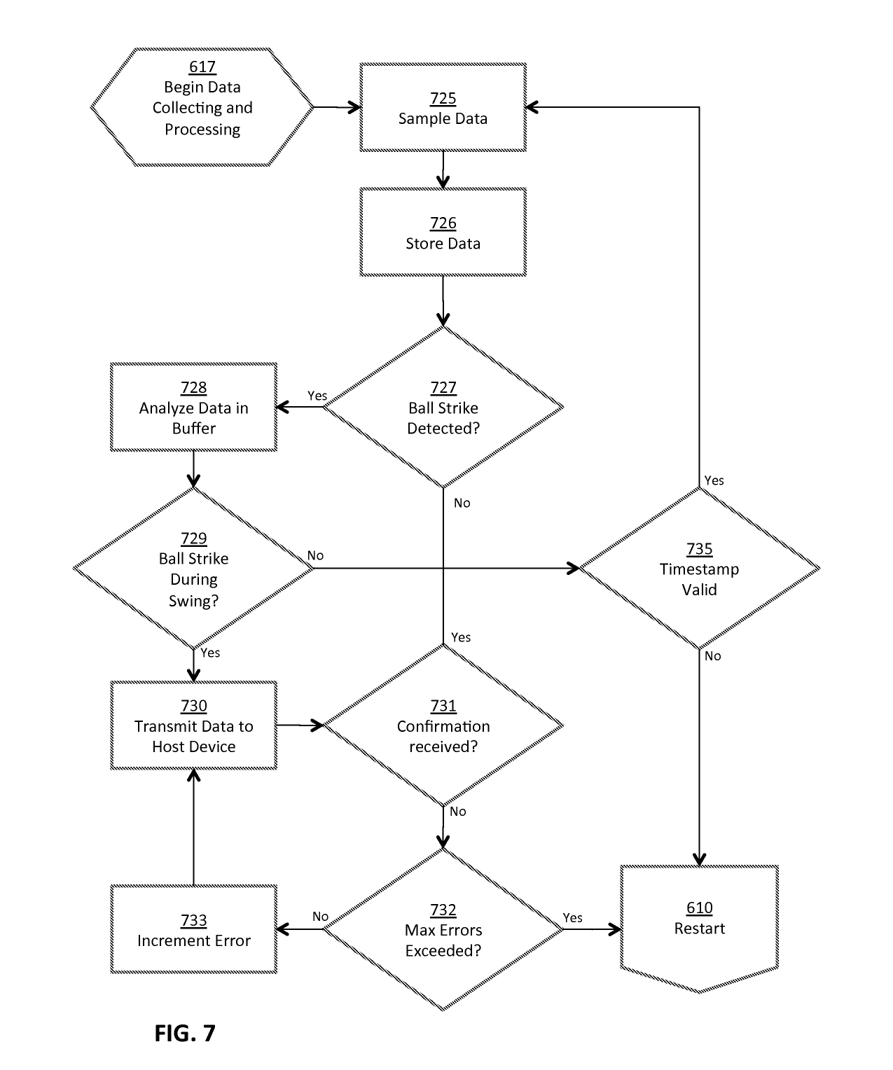

FIG. 7 is a flow chart depicting a method of a shaft evaluation device gathering and processing data for evaluating a swing of athletic equipment according to selected embodiments of the current disclosure. The shaft evaluation device begins data collecting and processing 617 by sampling data 725 of its associated sensors, including the microphone and accelerometers. The sampled data is then stored 726 in memory with an associated timestamp from its internal clock. In a particular embodiment, the sampled data is stored in a circular buffer, wherein the oldest stored data is overwritten with the newest data when necessary. After sampling and storing the data, the data is analyzed to determine whether an impact has been detected 727. An impact may be detected according to the process disclosed in the Swing Evaluation Disclosure. For example, an impact is determined to have occurred when the sampled data from the microphone meets predetermined criteria, such as from the head of a club striking a ball. If no impact is detected, the shaft evaluation device then proceeds to determine whether its timestamp data is still valid 735.

In another embodiment, each sampled data stored 726 in memory does not necessarily include a timestamp, but rather uses an accurate sampling rate along with one or more sampled data records that have an associated timestamp. For example, a timestamp can be associated with a first sample data record. Data is sampled at an accurate sampling rate, such as ten milliseconds. The second data sample is known to have occurred 10 milliseconds after the first, the third data sample is known to have occurred 20 milliseconds after the first, and so on. This can reduce the memory size required to store a sampled data set, thereby increasing the number of sampled data records that can be stored in memory. A timestamp can be associated with sampled data at set intervals to verify and/or reset the time associated with each record.

If an impact is detected 727, then the stored sampled data is further analyzed, 728, including the sampled data from the accelerometers. The shaft evaluation device then determines whether a ball strike occurred during a swing 729. A ball strike occurring during a swing may be determined according to the process disclosed in the Swing Evaluation Disclosure. For example, a ball strike may be determined to have occurred during a golf swing if the sampled data from the microphone and accelerometers meet predefined criteria. This minimizes false positives, such as when the shaft evaluation device strikes an object, but not during a swinging motion of the athletic equipment. If the detected ball strike did not occur during a swing, the shaft evaluation device then proceeds to determine whether its timestamp data is still valid 735.

If a ball strike is determined to have occurred during a swing 729, the shaft evaluation device transmits that a ball strike has occurred and the associated sampled data to the host device 730. The sampled data with its associated timestamp is transmitted to the host device for storage, display, and/or other processing. After transmitting the data to the host device 730, the shaft evaluation device should determine whether a confirmation has been received from the host device 731 confirming that the host device successfully received the transmitted data. If the confirmation is received, the shaft evaluation device then proceeds to determine whether its timestamp data is still valid 735. If, on the other hand, no confirmation was received from the host device after a period of time, or an error was received from the host device, the shaft evaluation device determines whether the maximum number of errors has been exceeded 732. By determining whether the maximum number of errors has been exceeded 732, the shaft evaluation device prevents itself from getting stuck in loop of constantly trying to resend the same data to the host device to no avail. The threshold for determining whether the maximum number of errors has been exceeded can be 1, 2, 5, 10, or any other number that a person skilled in the art would find reasonable for retrying the transmission of data in light of the intended use of the system and method disclosed herein. If the maximum number of errors is exceeded 732, then the shaft evaluation device proceeds to restart 610. This ensures that it creates an appropriate link and connection with the host device once again. If, on the other hand, the maximum number of errors is not exceeded 732, the number of errors is incremented 733, and the shaft evaluation device once again attempts to transmit the stored data to the host device 730.

When transmitting sampled data to the host, a particular embodiment of the current disclosure provides for transmitting a timestamp and sampling rate as header (or separate) data followed by the incremental sampled data records. The first record occurred at the time of the timestamp, and subsequent records occurred according to its record number and the sample rate. For example, if a timestamp of 100 milliseconds was transmitted with a sample rate of 5 milliseconds, the first record occurred at 100 milliseconds, and the fifth record occurred at 120 milliseconds. This can reduce the total data size that must be transmitted from the shaft evaluation device to the host device.

In a particular embodiment, the shaft evaluation device determines whether its timestamp is still valid 735. As discussed earlier, the internal clock of the shaft evaluation device was set using a timestamp obtained from the host device, or alternatively, the host device was sent a timestamp, which is used as an offset for determining the relative time of the shaft evaluation device to the host device. To ensure that the clocks are appropriately synchronized, if the previously obtained or transmitted timestamp has expired or is otherwise invalid, the shaft evaluation device should restart the setup process 610. If the previously obtained timestamp is still valid, then the shaft evaluation device should once again sample data 725 from its sensors. As one skilled in the art will appreciate, this process may proceed indefinitely until the shaft evaluation device is shut off.

In another embodiment, the determination of a ball strike 727 can be a separate process that sends an interrupt sequence to the microcontroller, causing it to then proceed to analyze the data in the buffer 728. In such an embodiment, the sampling and storing of data may be a separate process that is interrupted from time to time.

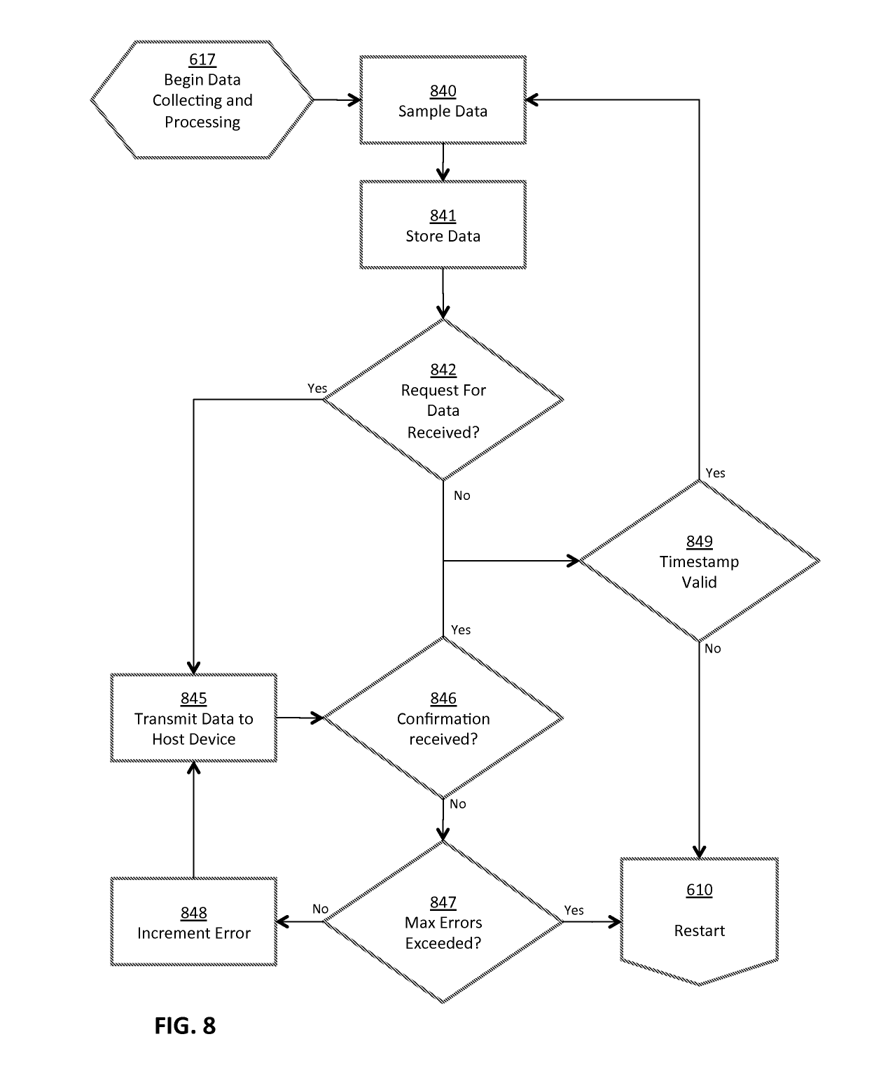

FIG. 8 is a flow chart depicting a method of a sole evaluation device gathering and processing data for evaluating a swing of athletic equipment according to selected embodiments of the current disclosure. The sole evaluation device begins data collecting and processing 617 by sampling data 840 of its associated sensors, including the pressure sensors. The sampled data is then stored 841 in memory with an associated timestamp from its internal clock. In a particular embodiment, the sampled data is stored in a circular buffer, wherein the oldest stored data is overwritten with the newest data when necessary. After sampling and storing the data, the sole evaluation device determines whether it has received a request for data 842. A request for data is sent by the host device when, for example, the host device has received data from a shaft evaluation device indicating that a swing and ball strike has occurred. If no such request is received, the sole evaluation device determines whether its previously obtained timestamp is still valid 849.

In another embodiment, and similar to that of the shaft evaluation device, each sampled data stored 726 in memory of the sole evaluation device does not necessarily include a timestamp, but rather uses an accurate sampling rate along with one or more sampled data records that have an associated timestamp.

If a request for data is received 842, the sole evaluation device then attempts to transmit its stored sampled data to the host device 845. After transmitting the data to the host device 845, the sole evaluation device should determine whether a confirmation has been received from the host device 846 confirming that the host device successfully received the transmitted data. If the confirmation is received, the sole evaluation device then proceeds to determine whether its timestamp data is still valid 849. If, on the other hand, no confirmation was received from the host device after a period of time, or an error was received from the host device, the sole evaluation device determines whether the maximum number of errors has been exceeded 847. By determining whether the maximum number of errors has been exceeded 847, the sole evaluation device prevents itself from getting stuck in loop of constantly trying to resend the same data to the host device to no avail. The threshold for determining whether the maximum number of errors has been exceeded can be 1, 2, 5, 10, or any other number that a person skilled in the art would find reasonable for retrying the transmission of data in light of the intended use of the system and method disclosed herein. If the maximum number of errors is exceeded 847, then the sole evaluation device proceeds to restart 610. This ensures that the sole evaluation device creates an appropriate link and connection with the host device once again. If, on the other hand, the maximum number of errors is not exceeded 847, the number of errors is incremented 848, and the sole evaluation device once again attempts to transmit the stored data to the host device 845.

In a particular embodiment, the request for data 842 from the host device to the sole evaluation device can include a timestamp, whereby the sole evaluation device transmits stored data to the host device that has an associated timestamp that is within a specified time period of requested timestamp. For example, the sole evaluation device may only transmit stored data with timestamps that are within the time range of the requested timestamp, and two seconds prior. Alternatively, instead of sending a timestamp and relying on a predetermined specified time period, two timestamps specifying a range, or an initial timestamp and a length of time are included with the request, where the sole evaluation device transmits stored data to the host device that falls within the range of the two timestamps or within the range of the initial timestamp and length of time.

Similar to the shaft evaluation device, when transmitting sampled data to the host from the sole evaluation device, a particular embodiment of the current disclosure provides for transmitting a timestamp and sampling rate as header (or separate) data followed by the incremental sampled data records.

In a particular embodiment, the sole evaluation device determines whether its timestamp is still valid 849. As discussed earlier, the internal clock of the sole evaluation device was set using a timestamp obtained from the host device, or alternatively, the host device was sent a timestamp, which is used as an offset for determining the relative time of the sole evaluation device to the host device. To ensure that the clocks are appropriately synchronized, if the previously obtained or transmitted timestamp has expired or is otherwise invalid, the sole evaluation device should restart the setup process 610. If the previously obtained timestamp is still valid, then the sole evaluation device should once again sample data 840 from its sensors. As one skilled in the art will appreciate, this process may proceed indefinitely until the sole evaluation device is shut off.

In another embodiment, the determination of whether a request for data has been received 842 can be a separate process that sends an interrupt sequence to the microcontroller, causing it to then proceed to transmit stored data to the host device 845. In such an embodiment, the sampling and storing of data may be a separate process that is interrupted from time to time.

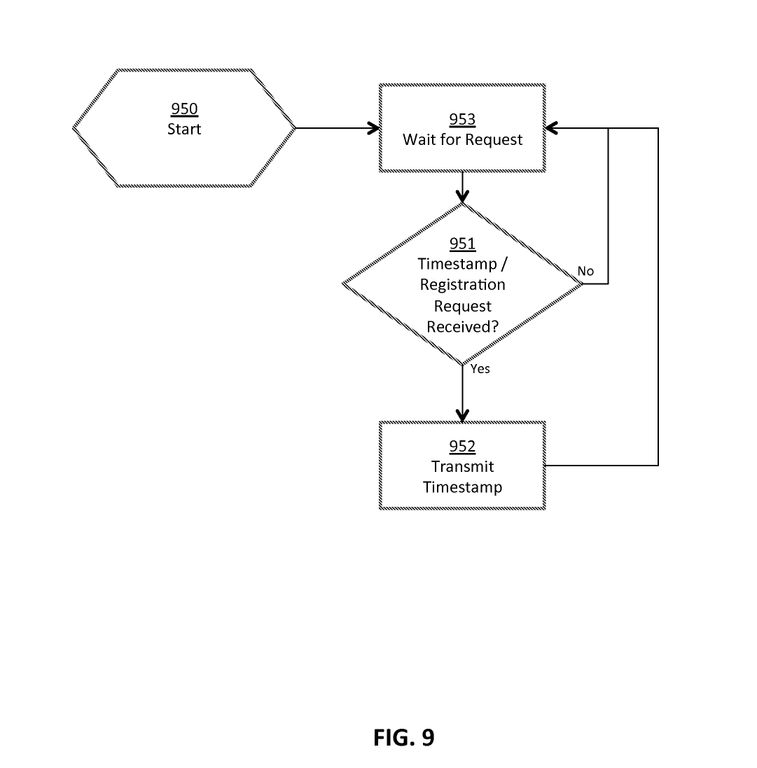

FIG. 9 is a flow chart depicting a method of providing a timestamp to an evaluation device according to selected embodiments of the current disclosure. The host evaluation device starts 950 the current method by waiting for a timestamp/registration request 953 from an evaluation device. The host device determines whether a timestamp has been received 951. If such a request has not been received, the host device once again waits for a request 953. If such a request is received, the host device transmits a timestamp 952 to the evaluation device. At the same time, the host device may also register the evaluation device.

The host device uses additional unique identifying data sent by the evaluation device, such as a MAC address and type of evaluation device (such as a shaft evaluation device or a sole evaluation device), to identify and keep track of associated evaluation devices, and the last time they requested an updated timestamp. Information regarding the status of each evaluation device can then be displayed to the user via the host device. Furthermore, this enables the host device to request data from appropriate sole evaluation devices when a ball-strike event is received from a shaft evaluation device.

In another embodiment, the determination of whether a registration and/or request for a timestamp has been received 951 can be a separate process that interrupts and transmits the timestamp to the evaluation device 952.

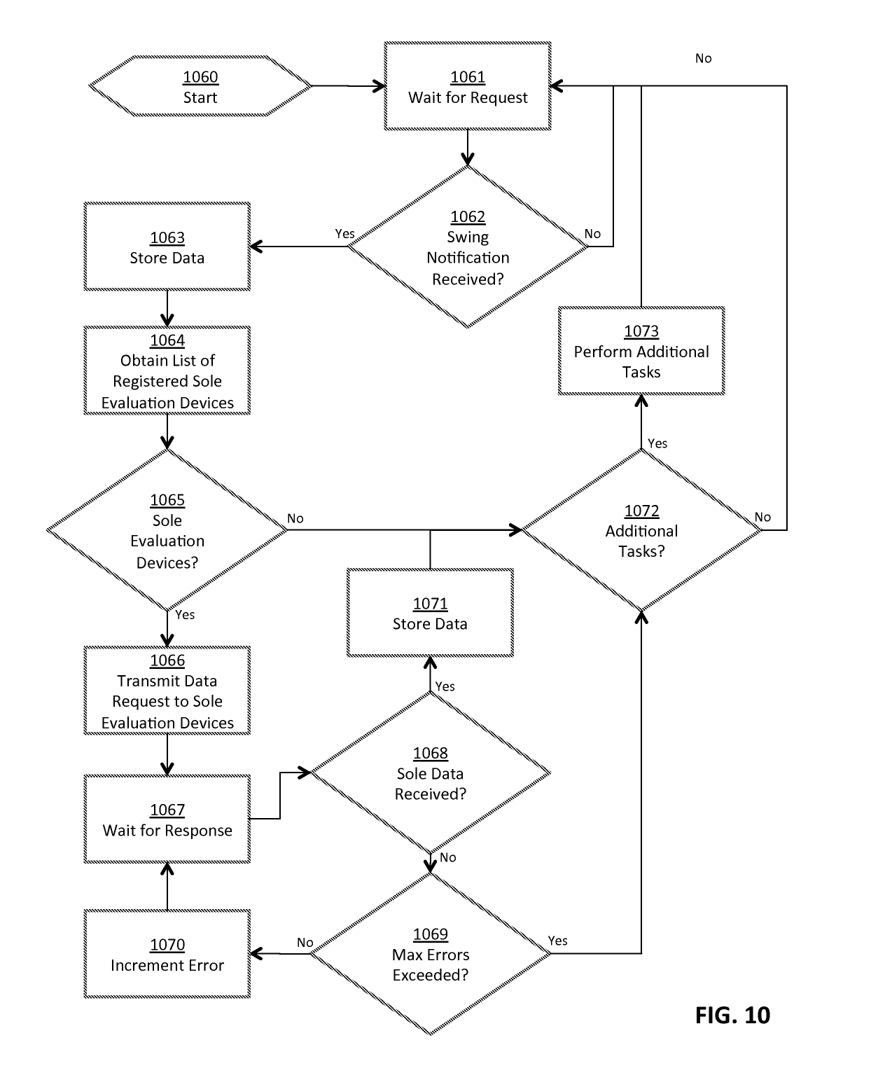

FIG. 10 is a flow chart depicting a method of collecting and storing data for evaluating a swing of athletic equipment. The host device starts 1060 by waiting for a request 1061. The host device determines whether it has received a swing and ball strike notification 1062 from an associated shaft evaluation device. If no such notification is received, the host device once again waits for a request 1061. If such a notification is received 1062, the host device stores the data 1063 and proceeds to obtain a list of registered sole evaluation devices 1064. Upon receipt of sampled data from a shaft evaluation device, a confirmation can also be transmitted to the respective shaft evaluation device confirming that the host device has successfully received the transmitted data. The host device then determines whether there are any registered sole evaluation devices 1065. If there are no sole evaluation devices, then the host device proceeds to determine whether there are any additional tasks that should be performed 1072.

If there are sole evaluation devices 1065, the host device transmits a data request to each sole evaluation device 1066, and then waits for a response 1067. When transmitting the data request to the one or more sole evaluation devices 1066, the host device may do so in series (i.e. requesting data from a first sole evaluation device and waiting for a response, then requesting data from a second sole evaluation device and waiting for a response, etc.) or in parallel (i.e. sending requests to multiple sole evaluation devices simultaneously, such as by using multiple threads, and waiting for a response from all sole evaluation devices). Upon receipt of sampled data from a sole evaluation device, a confirmation can be transmitted to the respective sole evaluation device confirming that the host device has successfully received the transmitted data. The host device determines whether it has received the appropriate sole data from the one or more registered sole evaluation devices 1068. If the host device has received the appropriate data from the sole evaluation devices, it stores the data 1071. After storing the data 1071, the host device moves on to determine if any additional tasks should be performed 1072.

If the host device has not received appropriate sampled data for the sole evaluation devices in a specified time period, or the data is invalid or otherwise not as required, the host device determines whether the maximum number of errors has been exceeded 1069. Similar to the method of the evaluation devices, this prevents the host device from getting stuck waiting for valid data from the sole evaluation devices. If the maximum number of errors has not been exceeded, the host device increments the error count 1070, and continues to wait for a valid response of sampled data from the sole evaluation devices. If the maximum number of errors has been exceeded, the host device moves on to determine if any additional tasks should be performed 1072.

The host device determines whether any additional tasks 1072 should be processed. If there are no additional tasks, the device continues on to wait for another request 1061. If there are additional tasks to be performed, the system performs the additional tasks 1073, and then continues on to wait for another request 1061. Additional tasks 1073 can include related processing of the data received from the evaluation devices, including indexing the data; further analyzing the data; consolidating the data; extrapolating conclusions and/or additional information from the data; updating a graphical user interface of the host device based upon the received data; and transmitting the data, consolidated data, extrapolated data, or other associated data to a cloud based system, remote server, or other device.

The data received from the shaft evaluation device and the sole evaluation devices is timestamped and synchronized together, as discussed above, enabling the data to be merged into a common time base. Therefore, there is data about the spatial movement of the athletic equipment that is correlated with the weight balance of the athlete not only between the two feet, but also where the relative weight is applied on each foot. This correlated data can be used in a variety of manners, including reconstructing a three-dimensional model of the athlete that shows real-life movement and weight balance throughout the swing of the athletic equipment by the athlete. In fact, this merged data allows for the breakdown of the swing into timed components and relate balance of the athlete with particular phases of her swing, such as the setup, takeaway, transition, and ball impact.

A particular embodiment of the current disclosures calls for the athletic equipment being a golf club. A plurality of shaft evaluation devices may be used, wherein a shaft evaluation device is affixed to each golf club of the athlete. Each shaft evaluation device is linked to the host device, and therefore whichever club the athlete uses to swing and strike a golf ball notifies the host device and transmits its data thereto. The host device then requests the data from each of the sole evaluation devices. In this manner, a golfer may seamlessly use the system and method according to the current disclosure to track and analyze her golf swing throughout an entire round of golf. Other sports and athletic equipment will also benefit from the system and method disclosed herein, including baseball (baseball bat), tennis (tennis racquet), and racquet ball (racquet ball racquet). A person skilled in the art will recognize that the present disclosure is not limited to a specific sport, but rather can be applied to any sport where a club of some sport strikes a ball, whether during an actual game or during practice or preparation for a game.

The host device, in a particular embodiment, includes a processor, radio, memory, and a user interface. Examples of such a device include without limitation smartphones (i.e. Apple® iPhone® or Android® mobile phones), tablets (i.e. Apple® iPad® or Google® Nexus®), mobile computers (i.e. laptops), and specially built electronic devices designed to integrate and interact specifically with the shaft evaluation and sole evaluation devices.

It should be understood that while the preferred embodiments of the invention are described in some detail herein, the present disclosure is made by way of example only and that variations and changes thereto are possible without departing from the subject matter coming within the scope of the current disclosure.

That which is claimed:

1. A system comprising:
a host device, where the host device comprises a processor, memory, and a radio;
a shaft evaluation device, where the shaft evaluation device comprises an accelerometer, a microcontroller, a radio, and memory; where the radio of the shaft evaluation device is in wireless communication with the radio of the host device; and
a sole evaluation device, where the sole evaluation device comprises a pressure sensor, a microcontroller, memory, and a radio, where the radio of the sole evaluation device is in wireless communication with the radio of the host device.

2. The system of claim 1, wherein the memory of the shaft evaluation device comprises a circular memory buffer.

3. The system of claim 1, wherein the memory of the sole evaluation device comprises a circular memory buffer.

4. The system of claim 1, wherein the pressure sensor of the sole evaluation device is located in a heel portion of the sole evaluation device.

5. The system of claim 1, wherein the sole evaluation device further comprises an additional pressure sensor, where the additional sensor is located in a ball portion of the sole evaluation device.

6. The system of claim 1, wherein the shaft evaluation device further comprises a ball-strike sensor.

7. The system of claim 6, wherein the shaft evaluation device further comprises programming logic executed by the microcontroller and for interfacing with the ball-strike sensor, accelerometer, radio, and memory, the programming logic configured to:
sample data from the ball strike sensor and accelerometer;
store the sampled data in the memory to create sampled data records; and
determine if a ball strike occurred during a swing.

8. The system of claim 7, wherein the programming logic of the shaft evaluation device is further configured to transmit at least a portion of the sampled data records to the host device.

9. The system of claim 7, wherein each sampled data record includes a timestamp.

10. The system of claim 7, wherein less than all of the sampled data records include a timestamp.

11. The system of claim 1, wherein the sole evaluation device further comprises programming logic executed by the microcontroller and for interfacing with the pressure sensor, radio, and memory, the programming logic configured to:
sample data from the pressure sensor;
store the sampled data in the memory to create sampled data records; and
transmit at least a portion of the of the sampled data records to the host device.

12. The system of claim 1, wherein the shaft evaluation device further comprises programming logic executed by the microcontroller and for interfacing with the radio, the programming logic configured to
request a timestamp from the host device.

13. The system of claim 1, wherein the shaft evaluation device further comprises programming logic executed by the microcontroller and for interfacing with the radio, the programming logic configured to
transmit a timestamp to the host device.

14. A method comprising
sampling data from a ball-strike sensor and an accelerometer of a shaft evaluation device, where each sampled data is referred to as a shaft sampled data record;
storing the shaft sampled data records in memory;
sampling data from a plurality of pressure sensors of a sole evaluation device, where each sampled data of a sole evaluation device is referred to as a sole sampled data record;
storing the sole sampled data records in memory;
determining whether a ball impact occurred during a swing; and
transmitting some or all of the shaft sampled data records and some or all of the sole sampled data records to a host device.

15. The method of claim 14, where sampling data from a ball-strike sensor and an accelerometer of a shaft evaluation device occurs at set intervals of time.

16. The method of claim 14, wherein sampling data from a plurality of pressure sensors of a sole evaluation device occurs at set intervals of time.

17. The method of claim 14, wherein the shaft sampled data records are transmitted to the host device only if it was determined that a ball impact occurred during a swing.

18. The method of claim 14, wherein each shaft sampled data record comprises a timestamp.

19. The method of claim 14, wherein a timestamp is transmitted to the host device with the shaft sampled data records.

20. The method of claim 19, further comprising the step of calculating, on the host device, a timestamp for a shaft sampled data record using the transmitted timestamp and a set interval of time.

21. The method of claim 14, wherein the step of sampling data from a ball-strike sensor and an accelerometer of a shaft evaluation device further includes sampling data from a gyroscope.

22. A method comprising
sampling data from a ball-strike sensor and an accelerometer of a shaft evaluation device at set intervals of time, where each sampled data is referred to as a shaft sampled data record, where the shaft evaluation device is secured to an article of athletic equipment;
storing the shaft sampled data records in memory;
sampling data from a plurality of pressure sensors of a first sole evaluation device at set intervals of time, where each sampled data of a first sole evaluation device is referred to as a first sole sampled data record;
storing the first sole sampled data records in memory;
sampling data from a plurality of pressure sensors of a second sole evaluation device at set intervals of time, where each sampled data of a second sole evaluation device is referred to as a second sole sampled data record;
storing the second sole sampled data records in memory;
determining whether a ball impact occurred during a swing;
transmitting some or all of the shaft sampled data records to a host device if it was determined that a ball impact occurred during a swing;
transmitting some or all of the first sole sampled data records to the host device upon request by the host device; and
transmitting some or all of the second sole sampled data records to the host device upon request by the host device;
whereby data about the spatial movement of the article by a user can be correlated with the weight balance of the first sole evaluation device and second sole evaluation device.
